(19) United States
(12) Patent Application Publication
(10) Pub. No.: US 2024/0222968 A1
(43) Pub. Date: Jul. 4, 2024

(54) MULTI-POWER SUPPLY SYSTEM AND MULTI-POWER SUPPLY METHOD

(71) Applicant: Wistron Corporation, New Taipei City (TW)

(72) Inventor: Kuan-Wei Hsu, New Taipei City (TW)

(73) Assignee: Wistron Corporation, New Taipei City (TW)

(21) Appl. No.: 18/296,355

(22) Filed: Apr. 5, 2023

(30) Foreign Application Priority Data
Dec. 30, 2022 (TW) 111150940

(51) Int. Cl. H02J 1/10; H02J 9/06

(52) U.S. Cl. CPC H02J 1/102; H02J 9/061

(57) ABSTRACT

A multi-power supply system and a multi-power supply method are provided. The multi-power supply system includes power suppliers and a controller. The controller receives an information of a system power, increases a number of at least one output power supplier of the power suppliers according to a rise of the system power, and decreases the number of the at least one output power supplier of the power suppliers according to a drop of the system power. Each of the at least one output power supplier generates a first power and provides a supplying power with a preset power value according to the first power. At least one of the power suppliers other than the output power supplier as a non-output power supplier generates a second power and stops providing the supplying power according to the second power.

### CROSS-REFERENCE TO RELATED APPLICATION

This application claims the priority benefit of Taiwan application serial no. 111150940, filed on Dec. 30, 2022. The entirety of the above-mentioned patent application is hereby incorporated by reference herein and made a part of this specification.

### BACKGROUND

### Technical Field

The disclosure relates to a power supply system and a power supply method, and particularly relates to a multi-power supply system and a multi-power supply method.

### Description of Related Art

A multi-power supply system includes multiple power suppliers. In an actual application of a data center, in an all running state, if a system load is in a light load, and the load is evenly distributed to each power supplier, the power suppliers are in an extremely light load state, which reduces a power conversion efficiency. Therefore, how to effectively manage power and save energy is one of the research focuses of those skilled in the art.

### SUMMARY

The disclosure is directed to a multi-power supply system and a multi-power supply method, which shorten a voltage rise time provided to a load by power suppliers.

An embodiment of the disclosure provides a multi-power supply system including multiple power suppliers and a controller. The controller is coupled to the power suppliers. The controller receives information of a system power, increases a number of at least one output power supplier in the power suppliers according to a rise of the system power, and decreases the number of the at least one output power supplier in the power suppliers according to a drop of the system power. Each of the at least one output power supplier generates a first power and provides a supplying power with a preset power value according to the first power, and at least one of the power suppliers other than the output power supplier as a non-output power supplier generates a second power and stops providing the supplying power according to the second power.

An embodiment of the disclosure provides a multi-power supply method including: receiving information of a system power; increasing a number of at least one output power supplier in multiple power suppliers according to a rise of the system power; decreasing the number of the at least one output power supplier in the power suppliers according to a drop of the system power; controlling each of the at least one output power supplier for generating a first power and providing a supplying power with a preset power value according to the first power; and controlling at least one of the power suppliers other than the at least one output power supplier as a non-output power supplier for generating a second power and stopping providing the supplying power according to the second power.

Based on the above description, the output power supplier generates the first power. The non-output power supplier generates the second power. A voltage value of the second power is smaller than a voltage value of the first power and greater than 0 volt. It should be noted that the power supplier is not turned off, but provides the second power smaller than the first power, and the output voltage is clamped to the first power. When the non-output power supplier is used as the output power supplier, a voltage rise time may be significantly shortened, and a purpose thereof is to prevent a load from rising rapidly, which may quickly provide energy to the load, and efficiency of the multi-power supply system at light load is improved.

To make the aforementioned more comprehensible, several embodiments accompanied with drawings are described in detail as follows.

### BRIEF DESCRIPTION OF THE DRAWINGS

FIG. 1 is a schematic diagram of a multi-power supply system according to an embodiment of the disclosure.

FIG. 2 is a schematic diagram illustrating efficiency of a multi-power supply system according to an embodiment of the disclosure.

FIG. 3 is a flowchart of a multi-power supply method according to an embodiment of the disclosure.

FIG. 4 is a schematic diagram of a power supplier according to an embodiment of the disclosure.

FIG. 5 is a schematic diagram of setting multiple rising threshold values and multiple dropping threshold values according to an embodiment of the disclosure.

FIG. 6 is a schematic diagram of a multi-power supply system according to an embodiment of the disclosure.

FIG. 7 is a flowchart of a multi-power supply method according to an embodiment of the disclosure.

### DESCRIPTION OF THE EMBODIMENTS

Some embodiments of the disclosure will be described in detail with reference to the accompanying drawings. For the referenced element symbols in the following description, when the same element symbols appear in different drawings, they will be regarded as the same or similar elements. These embodiments are only a part of the disclosure, and do not reveal all possible implementations of the disclosure. Rather, these embodiments are only examples within the scope of the patent application of the disclosure.

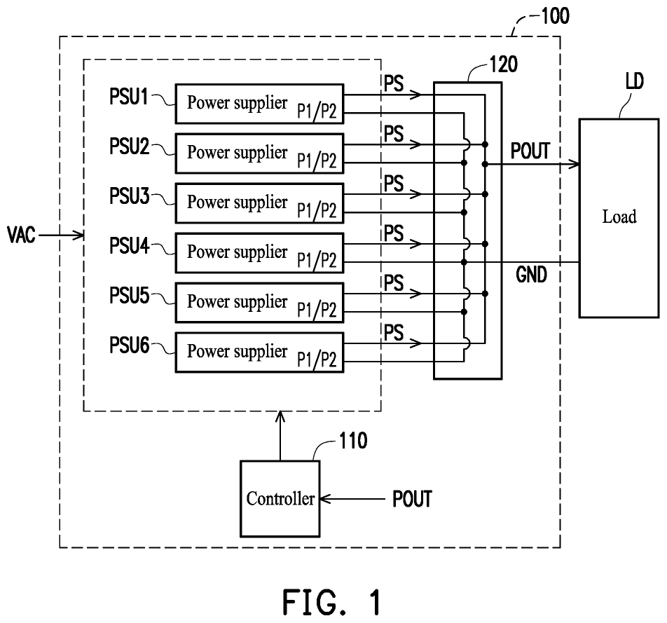

Referring to FIG. 1, FIG. 1 is a schematic diagram of a multi-power supply system according to an embodiment of the disclosure. In an embodiment, a multi-power supply system 100 includes power suppliers PSU1-PSU6 and a controller 110. The power suppliers PSU1-PSU6 respectively generate one of a first power P1 and a second power P2. For example, the power suppliers PSU1-PSU6 respectively receive an external power VAC, and use the external power VAC to generate one of the first power P1 and the second power P2. For example, the power suppliers PSU1-PSU6 may be arranged in a same cabinet.

The controller 110 is coupled to the power suppliers PSU1-PSU6. The controller 110 receives information of a system power POUT. The controller 110 may determine a variation of the system power POUT, and may change a number of output power suppliers in the power suppliers PSU1-PSU6 according to the variation of the system power POUT. The controller 110 increases the number of the output power suppliers in the power suppliers PSU1-PSU6 according to a rise of the system power POUT. The controller 110 decreases the number of the output power suppliers in the power suppliers PSU1-PSU6 according to a drop of the system power POUT. The system power POUT is related to a required power value of a load LD. Namely, variation of the required power value of the load LD may affect the system power POUT. The load LD includes at least one electronic device or apparatus. In an embodiment, the load LD and the power suppliers PSU1-PSU6 are, for example, commonly connected to the same ground GND.

The at least one output power supplier generates the first power P1. The at least one output power supplier provides a supplying power PS with a preset power value PD according to the first power P1. In an embodiment, the preset power value PD may be set through the controller 110. In addition, at least one non-output power supplier generates the second power P2. A voltage value of the second power P2 is smaller than the voltage value of the first power P1 and greater than 0 volt. The at least one non-output power supplier stops providing the supplying power PS according to the second power P2.

For example, in a first period, the power suppliers PSU1-PSU6 are all output power suppliers. Therefore, the power suppliers PSU1-PSU6 respectively generate the first power P1, and provide the supplying power PS with the preset power value PD according to the first power P1. A voltage value of the first power P1 is, for example, 54 volts. During a second period after the first period, the system power POUT drops. The controller 110, for example, sets the power supplier PSU6 to a non-output power supplier. Therefore, the power suppliers PSU1-PSU5 respectively generate the first power P1, and provide the supplying power PS with the preset power value PD according to the first power P1. The power supplier PSU6 generates the second power P2, and stops providing the supplying power PS according to the second power P2. A voltage value of the second power P2 is, for example, 48 volts. In a third period after the second period, the system power POUT rises. The controller 110 sets the power supplier PSU6 as the output power supplier. Therefore, the power supplier PSU6 raises the voltage value (such as 48 volts) of the second power P2 to the voltage value (such as 54 volts) of the first power P1, and provides the supplying power PS with the preset power value PD according to the first power P1.

It should be noted that the non-output power supplier is not turned off, but provides the second power P2. When the non-output power supplier is used as the output power supplier, a voltage rise time may be significantly shortened. In this way, during a process that the power supplier PSU6 is used as the output power supplier from the non-output power supplier, the voltage rise time of the power supplier PSU6 may be greatly reduced, which may quickly provide energy to the load when the load is prevented from rising rapidly. The efficiency of the multi-power supply system 100 at light load may be improved.

In an embodiment, the multi-power supply system 100 further includes a bus circuit 120. The bus circuit 120 is coupled to the power suppliers PSU1-PSU6. The bus circuit 120 receives at least one supplying power PS. The bus circuit 120 combines the received at least one supplying power PS into the system power POUT, and provides the system power POUT to the load LD. In some embodiments, the bus circuit 120 is disposed in the load LD.

In the embodiment, 6 power suppliers PSU1-PSU6 are taken as an example for description. The number of the power suppliers of the disclosure may be plural, but the disclosure is not limited thereto. In an embodiment, the controller 110 may receive the information of the system power POUT through the load LD or the bus circuit 120.

In an embodiment, the controller 110 is, for example, a central processing unit (CPU), or other programmable general purpose or special purpose microprocessor, digital signal processor (DSP), programmable controller, application specific integrated circuits (ASIC), programmable logic device (PLD) or other similar devices or a combination of these devices, which may load and execute computer programs.

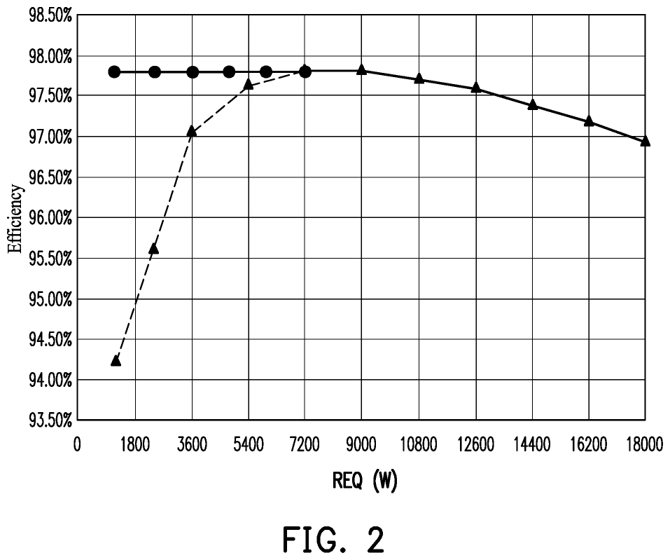

Referring to FIG. 1 and FIG. 2 at the same time, FIG. 2 is a schematic diagram illustrating efficiency of a multi-power supply system according to an embodiment of the disclosure. In FIG. 2, the dotted line shows an efficiency curve of a current operation of the multi-power supply system 100 supplying the system power POUT at a light load. In the dotted line, when a required power value REQ of the load LD is 1200 watts (W), the efficiency of the multi-power supply system 100 is 94.3%. When the required power value REQ of the load LD is 2400 W, the efficiency of the multi-power supply system 100 is 95.5%. When the required power value REQ of the load LD is 3600 W, the efficiency of the multi-power supply system 100 is 97%. When the required power value REQ of the load LD is 4800 W, the efficiency of the multi-power supply system 100 is 97.4%. When the required power value REQ of the load LD is 6000 W, the efficiency of the multi-power supply system 100 is 97.625%. When the required power value REQ of the load LD is 7200 W, the efficiency of the multi-power supply system 100 is about 97.83%.

In an embodiment, the output power supplier is at optimal efficiency when providing the supplying power PS with the preset power value PD. Furthermore, the preset power value PD of the power suppliers PSU1-PSU6 at optimal efficiency may be acquired. Specifications of the power suppliers PSU1-PSU6 record the preset power value PD corresponding to the optimal efficiency.

For example, after the design of the power supplier is completed, its efficiency curve has been fixed, and full-load power values of the power suppliers PSU1-PSU6 are respectively 3000 W. When the power suppliers PSU1-PSU6 provide the supplying power PS with a power value of 1200 W (for example, 40% of the full-load power value), the power suppliers PSU1-PSU6 are respectively at the optimal efficiency (for example, 97.83%). When the required power value REQ of the load LD is 1200 W, the number of the output power suppliers is one. When the required power value REQ of the load LD is 2400 W, the number of the output power suppliers is 2, and so on. Therefore, when the required power value REQ of the load LD is 1200, 2400, 3600, 4800, 6000, or 7200 W, the efficiency of the multi-power supply system 100 is substantially equal to the optimal efficiency.

Table 1 shows improvement results at light load. The efficiency of the embodiment is maintained at the optimal efficiency. Therefore, when the required power value REQ of the load LD is 1200 W, the power saved in the embodiment is about 45.92 W. When the required power value REQ of the load LD is 2400 W, the power saved in the embodiment is about 59.85 W. When the required power value REQ of the load LD is 3600 W, the power saved in the embodiment is about 31.49 W. When the required power value REQ of the load LD is 4800 W, the power saved in the embodiment is about 21.66 W. When the required power value REQ of the load LD is 6000 W, the power saved in the embodiment is about 12.88 W. When the required power value REQ of the load LD is 7200 W, the current operation and the efficiency E of the embodiment are all optimal efficiency. Therefore, the power value saved in the embodiment is about 0 W. Based on the above, when the required power value REQ of the load LD is less than 7200 W, the operation of the embodiment provides the power saving effect.

TABLE 1

| | Efficiency of | Efficiency of the | | |
|---|---|---|---|---|
| Required | current operation | embodimentand input | Saved | |
| power value | and power value of | power value of the | power | |
| of load | system input power | system power | value | |
| 1200 W | 94.3% | 97.83% | 45.92 | W |
| | 1272.53 W | 1226.61 W | | |
| 2400 W | 95.5% | 97.83% | 59.85 | W |
| | 2513.08 W | 2453.23 W | | |
| 3600 W | 97.0% | 97.83% | 31.49 | W |
| | 3711.34 W | 3679.85 W | | |
| 4800 W | 97.4% | 97.83% | 21.66 | W |
| | 4928.13 W | 4906.47 W | | |
| 6000 W | 97.625% | 97.83% | 12.88 | W |
| | 6145.96 W | 6133.08 W | | |
| 7200 W | 97.83% | 97.83% | 0 | W |
| | 7359.71 W | 7359.71 W | | |

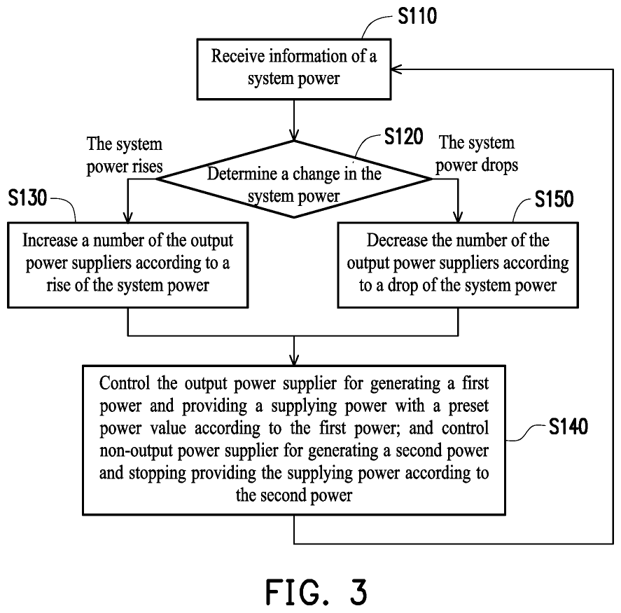

FIG. 3 is a flowchart of a multi-power supply method according to an embodiment of the disclosure. In an embodiment, in step S110, the controller 110 receives information of the system power POUT. In step S120, the controller 110 determines a change of the system power POUT through the information of the system power POUT. When it is determined that the system power POUT rises, the controller 110 increases a number of the output power suppliers according to the rise of the system power POUT in step S130. In step S140, the output power supplier generates the first power P1 and provides the supplying power PS with the preset power value PD according to the first power P1. The non-output power supplier generates the second power P2 and stops providing the supplying power PS according to the second power P2. When the step S140 ends, the multi-power supply method returns to the operation of the step S110.

When it is determined that the system power POUT drops, the controller 110 decreases the number of the output power suppliers according to the drop of the system power POUT in step S150. The multi-power supply method goes to the operation of step S140.

In step S120, when it is determined that the system power POUT does not change, the multi-power supply method goes to the operation of step S140.

The implementation details of steps S110-S150 have been clearly described in the embodiment of FIG. 1 and FIG. 2, which will not be repeated here.

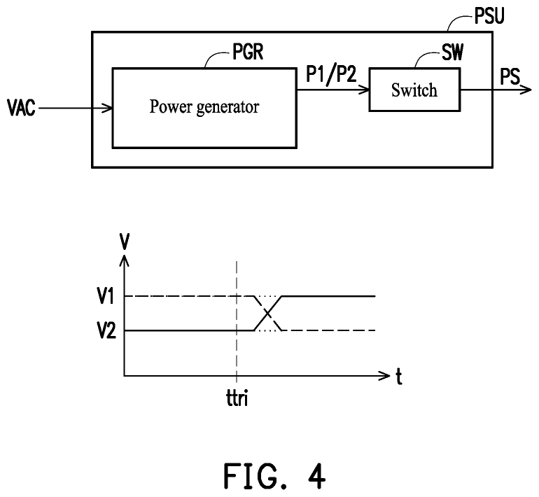

Referring to FIG. 4, FIG. 4 is a schematic diagram of a power supplier according to an embodiment of the disclosure. In an embodiment, a power supplier PSU includes a power generator PGR and a switch SW. The power generator PGR provides one of the first power P1 and the second power P2. In an embodiment, the power generator PGR receives an external power VAC. When the power supplier PSU is an output power supplier, the power supplier PSU provides the first power P1 according to the external power VAC. When the power supplier PSU is a non-output power supplier, the power supplier PSU provides the second power P2 according to the external power VAC.

In an embodiment, a first terminal of the switch SW is coupled to the power generator PGR. A second terminal of the switch SW is used as an output terminal of the power supplier PSU, and the switch SW is turned on according to the voltage value of the first power P1 to output the supplying power PS. In an embodiment, the first power P1 is substantially equal to the supplying power PS. In addition, the switch SW is turned off according to the voltage value of the second power P2.

In an embodiment, the switch SW performs a switching operation based on a power value. The switch SW is turned on based on a power value of the first power P1. The switch SW is turned off based on a power value smaller than the first power P1.

Referring to FIG. 1 and FIG. 4, in an embodiment, the power supplier PSU is, for example, one of the non-output power suppliers. At a trigger time point ttri, the controller 110 obtains the rise of the system power POUT through the information of the system power POUT, and controls a voltage value V2 of the second power P2 of the power supplier PSU to rise to a voltage value V1 of the first power P1 according to the rise of the system power POUT (shown as a voltage value change of a solid line). The second power P2 is changed to the first power P1. Therefore, the power supplier PSU is changed to an output power supplier.

In an embodiment, the power supplier PSU is, for example, one of the output power suppliers. At the trigger time point ttri, the controller 110 controls the voltage value V1 of the first power P1 of the power supplier PSU to drop to the voltage value V2 of the second power P2 according to the drop of the system power POUT (shown as a change of the voltage value indicated by the dotted line). The first power P1 is changed to the second power P2. Therefore, the power supplier PSU is changed to a non-output power supplier. In addition, the controller 110 blocks an under voltage protection operation of the non-output power supplier.

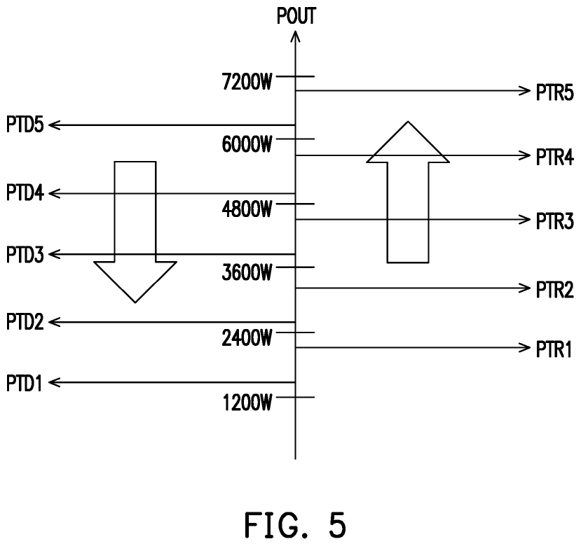

Referring to FIG. 1 and FIG. 5, FIG. 5 is a schematic diagram of setting multiple rising threshold values and multiple dropping threshold values according to an embodiment of the disclosure. In an embodiment, rising threshold values PTR1-PTR5 and dropping threshold values PTD1-PTD5 are set. The rising threshold values PTR1-PTR5 and the dropping threshold values PTD1-PTD5 are different from each other. For example, the dropping threshold value PTD1 is 1400 W. The dropping threshold value PTD2 is 2600 W. The dropping threshold value PTD3 is 3800 W. The dropping threshold value PTD4 is 5000 W. The dropping threshold value PTD5 is 6200 W. The rising threshold value PTR1 is 2200 W. The rising threshold value PTR2 is 3400 W. The rising threshold value PTR3 is 4600 W. The rising threshold value PTR4 is 5800 W. The rising threshold value PTR4 is 7000 W. However, the quantity and values of the rising threshold values and the dropping threshold values are not limited by the disclosure.

When the system power POUT drops to one of the dropping threshold values PTD1-PTD5, the controller 110 decreases the number of the output power suppliers. For example, when the system power POUT drops to the dropping threshold value PTD5, the controller 110 decreases the number of the output power suppliers from 6 to 5. When the system power POUT drops to the dropping threshold value PTD4, the controller 110 decreases the number of the output power suppliers from 5 to 4, and so on.

When the system power supply POUT rises to one of the rising threshold values PTR1-PTR5, the controller 110 increases the number of the output power suppliers. For example, when the system power POUT rises to the rising threshold value PTR1, the controller 110 increases the number of the output power suppliers from 1 to 2. When the system power POUT rises to the rising threshold value PTR2, the controller 110 increases the number of the output power suppliers from 2 to 3, and so on.

In an embodiment, the controller 110 may determine whether the system power POUT rises or drops according to a timing variation of the system power POUT. The controller 110 may subtract a power value of the system power POUT at a first time point from the power value of the system power POUT at a second time point to obtain a power difference, and may determine whether the system power POUT rises or drops according to a positive or negative value of the power difference. For example, at the first time point, the power value of the system power POUT is 1200 W. At the second time point, the power value of the system power POUT is 1000 W. The power difference is a negative value. Therefore, the controller 110 determines that the system power POUT is dropping. For another example, at the first time point, the power value of the system power POUT is 1000 W. At the second time point, the power value of the system power POUT is 1200 W. The power difference is a positive value. Therefore, the controller 110 determines that the system power POUT is rising.

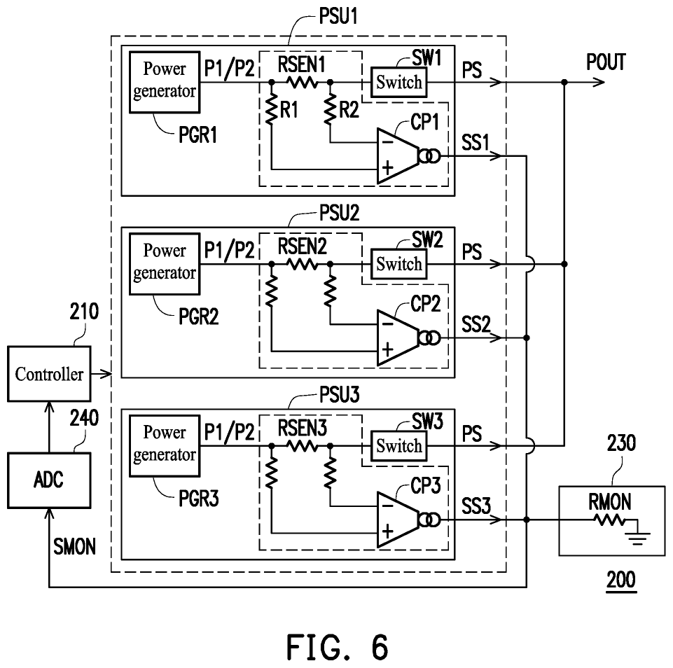

Referring to FIG. 6, FIG. 6 is a schematic diagram of a multi-power supply system according to an embodiment of the disclosure. In an embodiment, a multi-power supply system 200 includes power suppliers PSU1-PSU3 and a controller 210. The controller 210 is coupled to the power suppliers PSU1-PSU3. The controller 210 receives the system power POUT. The controller 210 increases the number of the output power suppliers in the power suppliers PSU1-PSU3 according to the increase of the system power POUT. The controller 210 decreases the number of the output power suppliers in the power suppliers PSU1-PSU3 according to the drop of the system power POUT. In other words, the controller 210 increases the number of the power suppliers as the output power suppliers according to the rise of the system power POUT, and the controller 210 decreases the number of the power suppliers as the output power suppliers according to the drop of the system power POUT.

In an embodiment, the power supplier PSU1 includes a power generator PGR1, a switch SW1 and a sensing circuit SEN1. The power generator PGR1 provides one of the first power P1 and the second power P2. The sensing circuit SEN1 is coupled to a first terminal of the switch SW1. The sensing circuit SEN1 senses the first power P1 generated by the power supplier PSU1 to provide a sensing signal SS1. A second terminal of the switch SW1 is used as an output terminal of the power supplier PSU1. In an embodiment, the switch SW1 is turned on according to a power value of the first power P1 to output the supplying power PS. The first power P1 is substantially equal to the supplying power PS. In addition, the switch SW1 is turned off according to a power value of the second power P2. Further, the power value of the second power P2 does not trigger the threshold value. The power supplier PSU1 does not perform the operation of raising voltage. The voltage value of the second terminal of the switch SW1 is greater than the voltage value of the first terminal of the switch SW1. Therefore, when the power supplier PSU1 provides the second power P2, the sensing circuit SEN1 does not provide the sensing signal SS1. Therefore, the sensing signal SS1 is related to the power value of the supplying power PS.

In an embodiment, the sensing circuit SEN1 includes a sensing resistor RSEN1 and a current amplifier CP1. The sensing resistor RSEN1 is coupled between the power generator PGR1 and the first terminal of the switch SW1. The current amplifier CP1 is coupled to both terminals of the sensing resistor RSEN1. The current amplifier CP1 provides the sensing signal SS1 according to a voltage difference between the two terminals of the sensing resistor RSEN1. When the power supplier PSU1 provides the second power P2, the switch SW is turned off. Therefore, the voltage difference between the two terminals of the sensing resistor RSEN1 is equal to zero. The sensing circuit SEN1 is equal to 0 (i.e., zero voltage or zero current).

In an embodiment, the current amplifier CP1 is also connected to one terminal of the sensing resistor RSEN1 through a resistor R1. The current amplifier CP1 is also connected to the other terminal of the sensing resistor RSEN1 through a resistor R2.

The power supplier PSU2 includes a power generator PGR2, a switch SW2 and a sensing circuit SEN2. The sensing circuit SEN2 includes a sensing resistor RSEN2 and a current amplifier CP2. The power supplier PSU3 includes a power generator PGR3, a switch SW3 and a sensing circuit SEN3. The sensing circuit SEN3 includes a sensing resistor RSEN3 and a current amplifier CP3. Configurations of the power suppliers PSU2, PSU3 are respectively similar to the configuration of the power supplier PSU1.

In an embodiment, the multi-power supply system 200 further includes a monitoring circuit 230. The monitoring circuit 230 is coupled to the sensing circuits SEN1-SEN3 and the controller 210. The monitoring circuit 230 receives the sensing signals SS1-SS3 provided by the sensing circuits SEN1-SEN3. The monitoring circuit 230 provides a monitoring signal SMON according to the sensing signals SS1-SS3. A voltage value of the monitoring signal SMON is related to the power value of the system power POUT.

In an embodiment, the current amplifier CP1 amplifies the sensing signal SS1, so that the sensing signal SS1 is equivalent to a current signal of the power supplier PSU1. The current amplifier CP2 amplifies the sensing signal SS2, so that the sensing signal SS2 is equivalent to a current signal of the power supplier PSU2. The current amplifier CP3 amplifies the sensing signal SS3, so that the sensing signal SS3 is equivalent to a current signal of the power supplier PSU3. The monitoring circuit 330 includes a monitoring resistor RMON. A first terminal of the monitoring resistor RMON receives the sensing signals SS1-SS3. A second terminal of the monitoring resistor RMON is coupled to a reference low potential (such as grounding). Therefore, the monitoring circuit 330 provides the monitoring signal SMON according to a sum of the sensing signals SS1-SS3 and a resistance value of the monitoring resistor RMON.

In an embodiment, the multi-power supply system 200 further includes an analog-to-digital converter (ADC) 240. The ADC 240 converts an analog format of the monitoring signal SMON into a digital format, and provides the monitoring signal SMON in the digital format to the controller 210. The controller 210 may acquire a change of the system power POUT according to the monitoring signal SMON. In an embodiment, a determination rule of the controller 210 may be set. For example, a load (the load LD shown in FIG. 1) may modify multiple rising threshold values and multiple dropping threshold values in the controller 210, set priorities of the output power suppliers or set a health judgment mode of the power suppliers PSU1-PSU3 through wired or wireless communication.

In an embodiment, multiple rising voltage threshold values and multiple dropping voltage threshold values are set. The rising voltage threshold values and the dropping voltage threshold values are different from each other. For example, when the voltage value of the monitoring signal SMON rises to one of the rising voltage threshold values, the controller 210 increases the number of the output power suppliers. When the voltage value of the monitoring signal SMON drops to one of the dropping voltage threshold values, the controller 210 decreases the number of the output power suppliers.

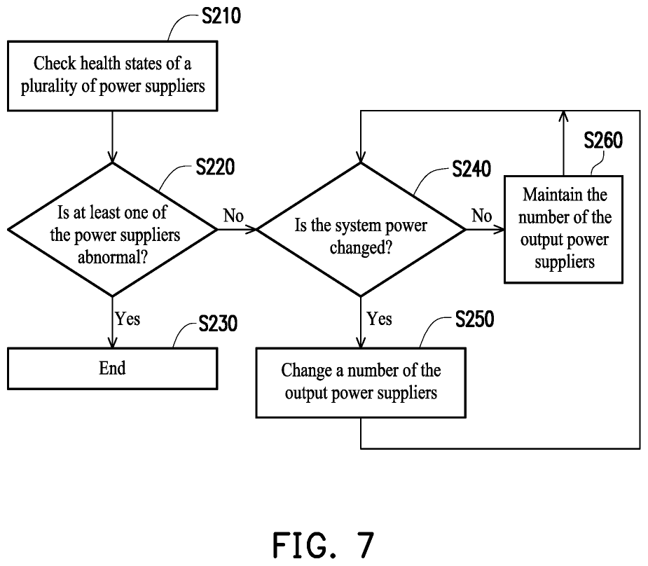

Referring to FIG. 1 and FIG. 7 at the same time, FIG. 7 is a flowchart of a multi-power supply method according to an embodiment of the disclosure. In an embodiment, in step S210, the controller 110 checks health states of the power suppliers PSU1-PSU6. In step S220, the controller 110 checks whether the power suppliers PSU1-PSU6 has abnormities such as over voltage, under voltage, short circuit, over temperature, etc. When at least one of the power suppliers PSU1-PSU6 is abnormal, the controller 110 terminates the operations of the power suppliers PSU1-PSU6 in step S230. On the other hand, when none of the power suppliers PSU1-PSU6 is abnormal, the controller 110 determines whether the system power POUT changes in step S240.

When the system power POUT changes, the controller 110 changes the number of the output power suppliers in step S250. For example, the controller 110 may calculate the rise or drop of the system power POUT through the embodiment shown in FIG. 5, and may change the number of the output power suppliers by using setting of the rising threshold values PTR1-PTR5 and the dropping threshold values PTD1-PTD5. For another example, the controller 110 may use the monitoring circuit 330 as shown in FIG. 6 to provide the monitoring signal SMON related to the power value of the system power POUT, and may change the number of the output power suppliers according to a change of the voltage value of the monitoring signal SMON. After completing the operation of step S250, the multi-power supply method returns to the operation of step S240.

In one embodiment, when the system power POUT does not change, the controller 110 does not change the number of the output power suppliers in step S260. Therefore, the number of the output power suppliers is maintained. Then, the multi-power supply method returns to step S240.

In summary, the non-output power supplier generates the second power. A voltage value of the second power is smaller than a voltage value of the first power and greater than 0 volt. It should be noted that the non-output power supplier is not turned off. When the non-output power supplier is used as the output power supplier, the voltage rise time may be significantly shortened. In this way, in the process that the power supplier is used as the output power supplier from the non-output power supplier, a time cost of the power supplier is greatly reduced, which prevents the load from rising rapidly, and quickly provides energy to the load. Moreover, the output power supplier is at the optimal efficiency when providing the supplying power with the preset power value. At a light load, the disclosure provides a power saving effect.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A multi-power supply system, comprising:
a plurality of power suppliers; and
a controller, coupled to the power suppliers, receiving information of a system power, increasing a number of at least one output power supplier in the power suppliers according to a rise of the system power, and decreasing the number of the at least one output power supplier in the power suppliers according to a drop of the system power,
wherein each of the at least one output power supplier generates a first power and provides a supplying power with a preset power value according to the first power,
wherein at least one of the power suppliers other than the output power supplier as a non-output power supplier generates a second power and stops providing the supplying power according to the second power.

2. The multi-power supply system according to claim 1, wherein a voltage value of the second power is smaller than a voltage value of the first power and greater than 0 volt.

3. The multi-power supply system according to claim 1, wherein each of the at least one output power supplier operates at optimal efficiency in response to the supplying power being provided with the preset power value.

4. The multi-power supply system according to claim 1, wherein each of the power suppliers comprises:
a power generator, configured to provide the first power or the second power;
a switch, having a first terminal coupled to the power generator and a second terminal used as an output terminal of a corresponding power supplier, and for being turned on according to a power value of the first power for outputting the supplying power and being turned off according to a power value of the second power.

5. The multi-power supply system according to claim 4, wherein
the switch performs a switching operation based on a switching threshold value,
a voltage value of the first power is greater than the switching threshold value, and
a voltage value of the second power is less than the switching threshold value.

6. The multi-power supply system according to claim 4, wherein each of the power suppliers further comprises:
a sensing circuit, coupled to the first terminal of the switch, and senses the first power generated by the corresponding power supplier to provide a sensing signal.

7. The multi-power supply system according to claim 6, wherein the sensing circuit comprises:
a sensing resistor, coupled between the power generator and the first terminal of the switch; and
a current amplifier, coupled to two terminals of the sensing resistor, and provides the sensing signal according to a voltage difference between the two terminals of the sensing resistor.

8. The multi-power supply system according to claim 6, further comprising:
a monitoring circuit, coupled to a plurality of sensing circuits of the power suppliers and the controller, receives a plurality of sensing signals provided by the sensing circuits and provides a monitoring signal according to the sensing signals,
wherein a voltage value of the monitoring signal is related to a power value of the system power.

9. The multi-power supply system according to claim 1, wherein
the controller controls a voltage value of the second power of the at least one of the power suppliers as the non-output power supplier to rise to a voltage value of the first power according to the rise of the system power, and
the controller controls a voltage value of the first power of the power suppliers as the at least one output power supplier to drop to the voltage value of the second power according to the drop of the system power.

10. The multi-power supply system according to claim 1, wherein
a plurality of rising threshold values and a plurality of dropping threshold values are set,
the rising threshold values and the dropping threshold values are different from each other,
in response to the system power dropping to one of the dropping threshold values, the controller decreases the number of the at least one output power supplier, and
in response to the system power rising to one of the rising threshold values, the controller increases the number of the at least one output power supplier.

11. The multi-power supply system according to claim 1, wherein the controller blocks an undervoltage protection operation of the at least one of the power suppliers other than the at least one output power supplier as the non-output power supplier.

12. A multi-power supply method for a plurality of power suppliers, comprising:
receiving information of a system power;
increasing a number of at least one output power supplier in the power suppliers according to a rise of the system power;
decreasing the number of the at least one output power supplier in the power suppliers according to a drop of the system power;
controlling each of the at least one output power supplier for generating a first power and providing a supplying power with a preset power value according to the first power; and
controlling at least one of the power suppliers other than the at least one output power supplier as a non-output power supplier for generating a second power and stopping providing the supplying power according to the second power.

13. The multi-power supply method according to claim 12, wherein a voltage value of the second power is smaller than a voltage value of the first power and greater than 0 volt.

14. The multi-power supply method according to claim 12, wherein each of the power suppliers comprises a switch and a power generator, wherein a first terminal of the switch is coupled to the power generator, and a second terminal of the switch is used as an output terminal of a corresponding power supplier, wherein the step of controlling each of the at least one output power suppliers for generating the first power and providing the supplying power with the preset power value according to the first power comprises:
turning on the switch according to a voltage value of the first power for outputting the supplying power.

15. The multi-power supply method according to claim 14, wherein the step of controlling the at least one of the power suppliers other than the at least one output power supplier as the non-output power supplier other than the for generating the second power and stopping providing the supplying power according to the second power comprises:
turning off the switch according to a voltage value of the second power.

16. The multi-power supply method according to claim 12, further comprising:
controlling the second power of the at least one of the power suppliers other than the at least one output power supplier as the non-output power supplier for rising to the first power according to the rise of the system power; and
controlling the first power of one of the at least one output power suppliers for dropping to the second power according to the drop of the system power.

17. The multi-power supply method according to claim 12, further comprising:
setting a plurality of rising threshold values and a plurality of dropping threshold values, wherein the rising threshold values and the dropping threshold values are different from each other.

18. The multi-power supply method according to claim 17, wherein the step of increasing the number of the at least one output power supplier in the power suppliers according to the rise of the system power comprises:
increasing the number of the at least one output power supplier in response to the system power rising to one of the rising threshold values.

19. The multi-power supply method according to claim 17, wherein the step of decreasing the number of the at least one output power supplier in the power suppliers according to the drop of the system power comprises:
decreasing the number of the at least one output power supplier in response to the system power dropping to one of the dropping threshold values.

20. The multi-power supply method according to claim 12, further comprising:
blocking an under voltage protection operation of the at least one of the power suppliers other than the at least one output power supplier as the non-output power supplier.
